(19) United States
(12) Patent Application Publication
(10) Pub. No.: US 2004/0202923 A1
(43) Pub. Date: Oct. 14, 2004

(54) 911 three flashlights in one

(76) Inventors: John P. Zazzara SR., So.Plainfield, NJ (US); James J. Denker SR., Monmouth Beach, NJ (US)

Correspondence Address: JOHN P. ZAZZARA SR., 203 OAK MANOR PKWY., SO. PLAINFIELD, NJ, 07080, US

(21) Appl. No.: 10/412,084

(22) Filed: Apr. 14, 2003

(51) Int. Cl. H01M 2/10

(52) U.S. Cl. 429/99; 429/9; 429/96

(57) ABSTRACT

A Flashlight construction, which allows for extended operation by switching to auxiliary battery power. The aux battery power is accomplished by storing 3 sets of AA batteries in a chamber compartment of the flashlight housing. The switching operation is accomplished by rotating a 12-pole rotary switch embedded into the end of the battery housing assembly. This configuration provides for extended usage during emergency operations without the need to change battery cells The battery cell assembly fits into a standard “D” sized flashlight. The AA batteries are paired electrically to provide equivalent “D” sized battery voltages and currents.

Clear acrylic plastic cylinder AA battery holder assembly on a vertical plane 1.250 OD. 1.185 ID. 5.000 L No. 2a 2b and 2c clear acrylic plastic AA battery guides 3.050 L. 0.024 W. 0.0125 T.

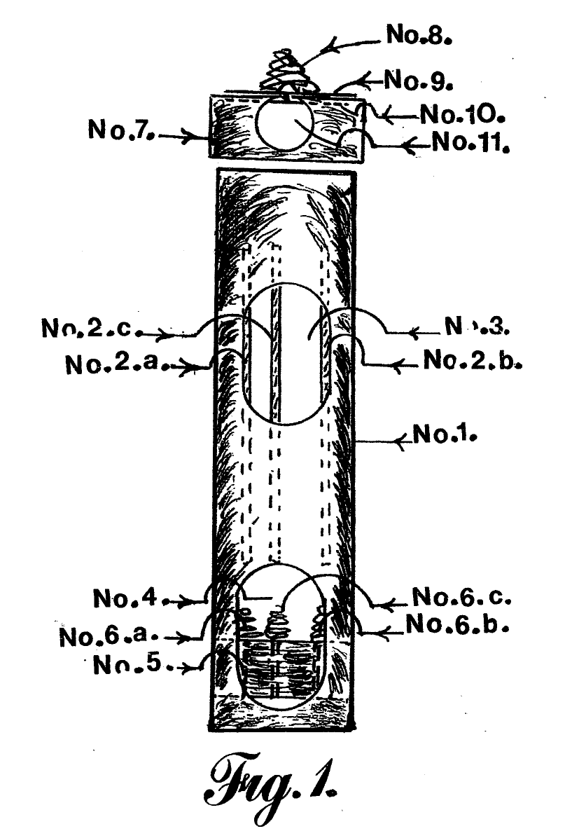

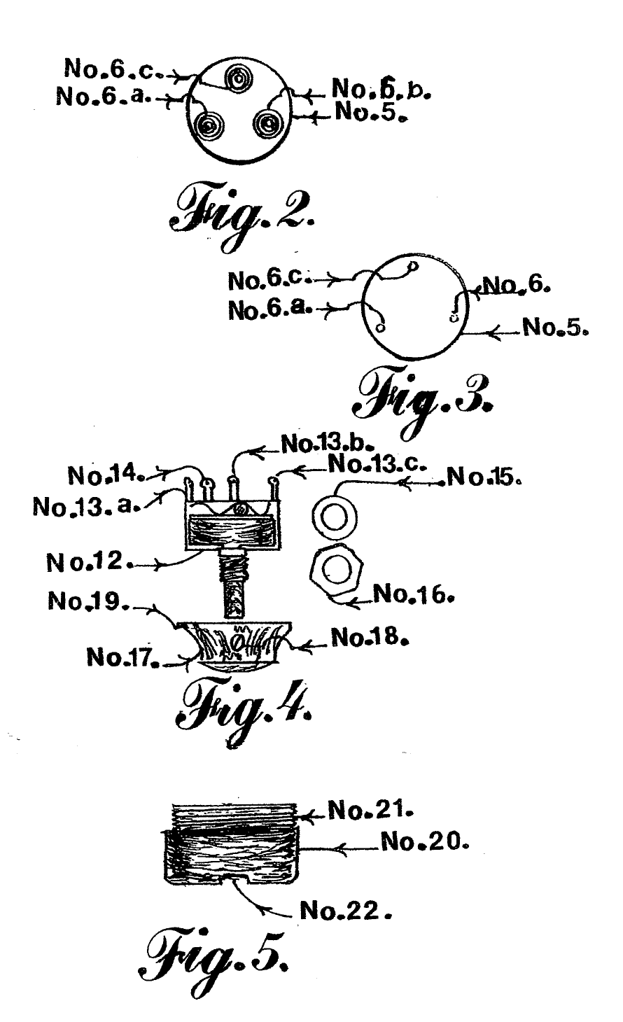

Attached to the inner surface of the acrylic plastic cylinder as follows: No. 2a positioned at the 2 o'clock position as view from the bottom. No 2b positioned at the 10 o'clock position As viewed from the bottom. No. 2c positioned at the 6 o'clock position as viewed from the bottom of the clear acrylic plastic cylinder No. 1 as per FIG. 1. Cut-out view No. 3 as per FIG. 1 top of holder show battery guide position ⅝″ from top of holder as per FIG. 1. cut-out view showing AA battery guides. No 4. Cut-out view showing negative soft steel cone shaped AA battery tension springs 0.50 diameter 0.5 height 0.55 thickness No. 6a No. 6b and No. 6c. No. 5. acrylic clear plastic cylinder housing for negative 26 Ga. copper ground wire soldered to No. 6a 0.210 d hole positioned at 8 o'clock and No. 6b 0.210 d hole positioned at 4 o'clock and No. 6c 0.210 d hole positioned at 12 o'clock. as per FIG. 2 and FIG. 3. No. 7. Acrylic plastic end cap 1.075 OD. 1.040 Id. 0.50 H. No. 8 cone shaped soft steel positive tension spring 0.78″ bottom circumference. 0.75″ height soldered to No. 9 polished brass circular plate 1.25″ diameter 0.011″ thickness. No. 10. Inside polished brass circular plate 1.25″ diameter 0.11″ thickness solders to No. 9. No. 11 cut-out view exposing positive contact plate as per FIG. 1. No. 12 single pole three position rotating switch as per FIG. 4 No 13 a channel 1 pole position which as attached to No. 6a as per FIG. 2. No 13 b channel 2 pole position which as attached to No. 6 c as per FIG. 2. No 13 c channel 3-pole position, which as attached to No. 6b as per FIG. 2. No. 14 main post bent 90 degrees and solder switch housing No. 12. No. 15 outer retainer washer 0.545 OD. 0.360 Id. As per FIG. 4. No. 16 6 point 10 mm nut as per FIG. 4. No. 17 plastic knob 1.30 OD. 0.625″ h with 0.230 diameter recess hole with No. 18 set screw as per FIG. 4. Knob consisting of Bakelite material with indicator marking No. 19 as per FIG. 4. Negative end of steel flashlight assembly screw in holder for standard steel or MAC flashlight housing using 2 “D” batteries as per FIG. 5 No. 21 showing standard threads for D sized flashlights as per FIG. 5. No. 22 0.070 diameter hole for 3 position switch assembly mounting as per FIG. 5. No. 5 inserted into chamber No. 1 and aligned to proper position, forming chambers 1, 2 and 3 to be held with liquid acrylic glue (methylene chloride cement for acrylic) as per FIG. 1. No. 12 rotary switch terminals then soldered to No. 6a, No. 6b and No. 6c. Upon assembly entire housing assembly is inserted into No. 21 and epoxy glued is then painted on the outside surface of No. 20.

1. We claim that our patent will now will be able to replace 2 “D” batteries with a triple chamber holding 2 AA batteries in each chamber. Making it possible to switch from channel A which have gone dead to channel B or C holding 2 fresh AA batteries. Therefore by controlling the knob at base of flashlight you now have 3 flashlights in 1 at all times. Our patent can be adapted to most steel or magnesium flashlights
